(19) United States
(12) Patent Application Publication
(10) Pub. No.: US 2004/0243385 A1
(43) Pub. Date: Dec. 2, 2004

(54) Emulation of hardware devices in a pre-boot environment

(76) Inventors: Michael A. Rothman, Gig Harbor, WA (US); Vincent J. Zimmer, Federal Way, WA (US)

Correspondence Address: Anthony H. Azure, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/448,868

(22) Filed: May 29, 2003

(51) Int. Cl. G06F 9/455

(52) U.S. Cl. 703/24

(57) ABSTRACT

A method and system to emulate a hardware device of a computer system. A missing device not present in a computer system is emulated by a device emulator. A request is made to access the missing device of the computer system and the request is serviced by the device emulator. In one embodiment, a floppy disk drive is emulated by a Random Access Memory (RAM) drive. The RAM drive is loaded with data anticipated to be requested from the floppy disk drive. A request to access the floppy disk drive is directed to the RAM drive by firmware executable by the computer system. In another embodiment, the firmware of the computer system operates in accordance with the Extensible Firmware Interface (EFI) framework standard to emulate a hardware device.

### FIELD OF THE INVENTION

The field of invention relates generally to computer systems and, more specifically but not exclusively, relates to emulating a hardware device of a computer system.

### BACKGROUND INFORMATION

During a computer system start-up, the computer system is self-tested and initialized through loading and execution of system firmware. Under personal computer (PC) architectures, this firmware is commonly referred to as the system's Basic Input/Output System (BIOS). In a typical PC architecture, the BIOS is generally defined as the firmware that runs between the processor reset and the first instruction of the Operating System (OS) loader. This is commonly referred to as the pre-boot phase and precedes the OS boot phase. At the start of a boot, very little of the system beyond the processor and firmware is actually initialized. It is up to the code in the firmware to initialize the system to the point that an operating system loaded off of media, such as a hard disk, can take over.

Computer systems, such as personal computers, operate through the interaction of application software, the operating system and the BIOS. Generally, the BIOS honors requests from the operating system to conduct operations on the various hardware devices in a computer system. The commands to a hardware device are based on the particular configuration of a PC. The BIOS allows operating systems and applications to work the same on a variety of different computers with different hardware configurations. The BIOS executes low-level commands to manage the various hardware components.

In a typical scenario, a user chooses a command to save a word processing file to a magnetic hard disk. The word processing application sends the save command to the operating system. The operating system will modify its directory structure accordingly, as well as take care of other housekeeping functions, and then hand off the details of saving the file to the BIOS. The BIOS retrieves the data for the file and issues commands to the disk-drive controller to save the data to the hard disk. The commands issued by the BIOS are tailored specifically for that particular hardware device. The BIOS commands are translated into electrical signals to save the data on the disk's surface. Thus, the BIOS is responsible for low-level communication with hardware devices of the computer system.

Many future computer systems will be shipped without some hardware pieces that today are very common. However, today's operating systems make assumptions about the presence of certain pieces of hardware in a computer system, such as a floppy disk drive. The inconsistency between platform configuration and OS expectations creates system problems.

For example, an operating system, such as those manufactured by the Microsoft Corporation, often require the presence of floppy disk drive during operating system installation. The operating system will ask the user to insert a floppy disk having necessary data. However, on a computer system without a floppy disk drive, the user has no way to satisfy this request by the OS.

### BRIEF DESCRIPTION OF THE DRAWINGS

The present invention is illustrated by way of example and not limitation in the accompanying figures.

FIG. 1 is a schematic diagram of a computer system according to one embodiment of the present invention.

FIG. 2 is a flowchart illustrating the logic and operations performed by one embodiment of the invention to emulate a hardware device of a computer system.

FIG. 3 is a flowchart illustrating the logic and operations performed by one embodiment of the invention to create and store a firmware recovery image.

FIG. 4 is a schematic diagram illustrating a computer system that may be used to practice an embodiment of the present invention.

### DETAILED DESCRIPTION

Embodiments of a method to emulate a hardware device and computer apparatus for implementing the method are described herein. In the following description, numerous specific details are set forth, such as embodiments pertaining to the Extensible Firmware Interface (EFI) framework, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

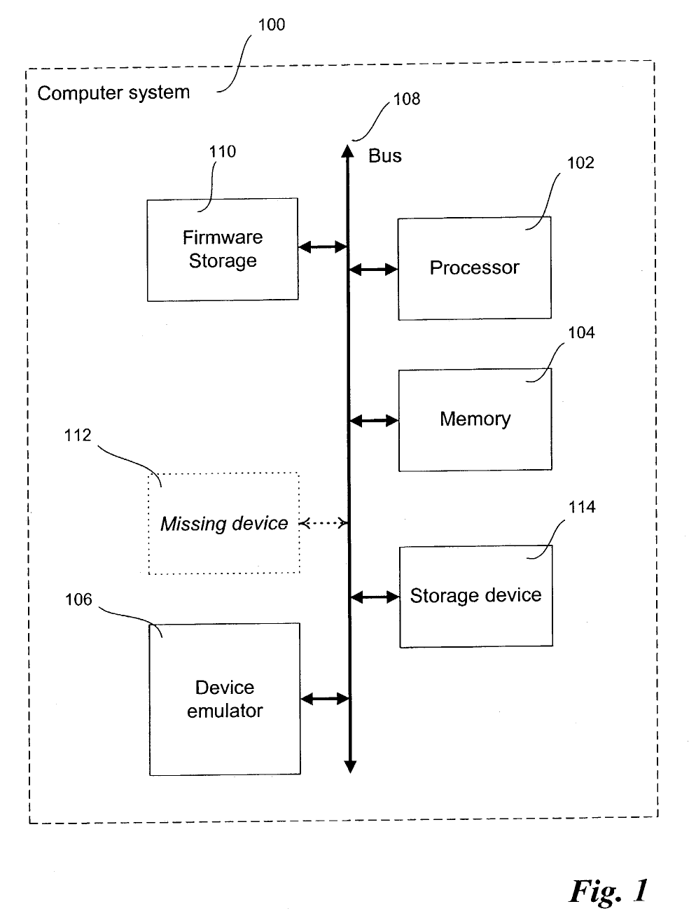

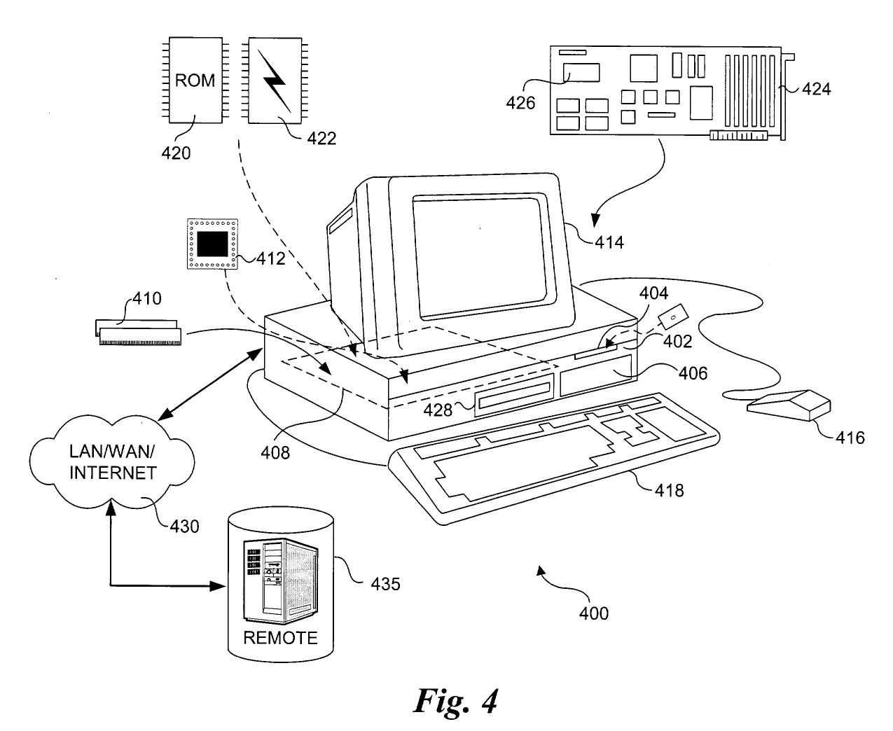

With reference to FIG. 1, a computer system 100 having an emulated hardware device in accordance with one embodiment of the invention is shown. The computer system 100 includes a processor 102, a memory 104, and a firmware storage 110 coupled to a bus 108. Generally, computer system 100 may include, but is not limited to, a personal computer, a network workstation, a portable computer, a handheld or palmtop computer, a personal digital assistant (PDA), a wireless phone, a digital camera, or the like. In one embodiment, computer system 100 is configured in a similar manner to an exemplary computer system discussed below in conjunction with FIG. 4.

The firmware storage 110 is a non-volatile storage device including, but not limited to, a flash memory device, an Erasable Programmable Read Only Memory (EPROM), an Electronically Erasable Programmable Read Only Memory (EEPROM), or the like. In one embodiment, firmware storage 110 stores BIOS firmware executable by computer system 100.

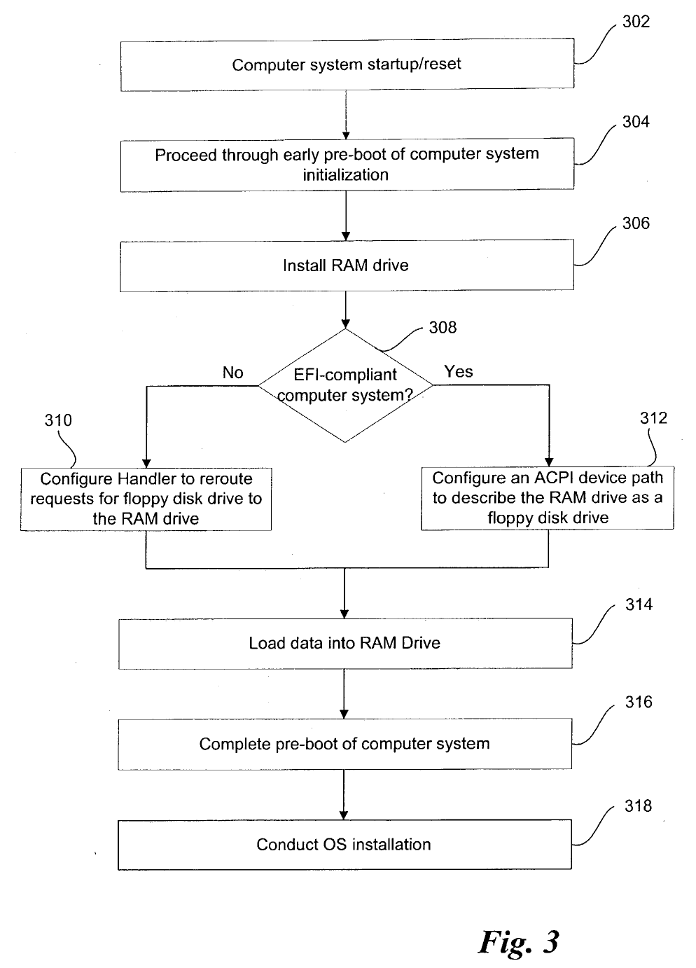

In one embodiment of the present invention, firmware storage 110 includes instructions and/or data in accordance with an EFI framework standard (specifications and examples of which may be found at http://developer.intel.com/technology/efi). Today's firmware architectures include provisions for extending BIOS functionality beyond that provided by the BIOS code stored in a platform's BIOS device (e.g., flash memory). More particularly, the Extensible Firmware Interface enables firmware, in the form of firmware modules and drivers, to be loaded from a variety of different resources, including primary and secondary flash devices, option ROMs (Read-Only Memory), various persistent storage devices (e.g., hard disks, CD ROMs (Compact Disk-Read Only Memory), etc.), and even over computer networks. In one implementation of the EFI framework, the initialization process includes various execution phases of firmware stored on the computer system 100. These execution phases include a Pre-EFI Initialization (PEI) phase, a Driver execution Environment (DXE) phase, and an EFI 1.0 execution phase. These phases enable initialization and set-up of various platform devices and services, and enable an operating system to be booted in accordance with an OS launch phase that follows the EFI 1.0 execution phase. The EFI framework will be discussed further in conjunction with FIG. 3.

In one embodiment, the firmware storage 110 is a flash memory device. Those skilled in the art will understand that the invention may be implemented in other types of persistent storage devices for maintaining firmware code and/or data, and the embodiments of the invention using flash devices discussed herein are merely exemplary schemes for practicing the invention.

Flash Memory is a non-volatile memory technology that allows manufacturers and (with the appropriate hardware/software) end users to electrically erase and (re)program information. Flash Memory is typically erased in units of memory called blocks instead of being erased at the bit level, wherein all bits in a given block are switched to a predetermined polarity (i.e., logic level) when the block is erased. In one embodiment, the block size is 64k. In another embodiment, the block size is 32k. In one common type of flash memory, such as flash memory devices manufactured by the Intel Corporation, blocks of memory are erased electronically by setting all bits in a block to 1's. Data can then be written to the block by flipping individual bits to 0's to form appropriate bit patterns corresponding to the data. In other types of flash devices, the erased logic state is all 0's, and writing data to these devices involves changing individual bits to 1's. It is noted that in conventional flash devices, individual bits cannot be flipped from a changed (i.e., set) logic level back to the erased logic level; in order to update data in a block, all of the bits have to be erased first, and then rewritten.

Referring to FIG. 1, a device emulator 106 is coupled to bus 108. Device emulator 106 is used to emulate a missing hardware device 112. Missing hardware device 112 is shown in FIG. 1 with dotted lines to highlight that the missing hardware device 112 does not exist, but instead will be emulated by device emulator 106. As discussed below in further detail, any requests for access to the missing hardware device 112 are directed to device emulator 106. A hardware device will be “faked” such that the requester will believe the computer system 100 is populated with items that are not there. The requester is unaware of the emulation and perceives the missing hardware device 112 as actually being present in the computer system 100.

In one embodiment, a Random Access Memory (RAM) drive (also referred to as a “RAM disk”) emulates a storage device, such as a magnetic disk drive. Data can be read and written to the RAM drive as if it is a magnetic disk drive. A typical RAM drive refers to memory that has been configured to simulate a disk drive (e.g., a magnetic disk drive, an optical disk drive, etc.), and is well known in the art. Files can be stored and retrieved from the RAM drive as if the files were stored on a conventional disk. The RAM drive is usually assigned a drive letter and regarded by the operating system as another drive accessible to the computer system.

Referring back to FIG. 1, in one embodiment, device emulator 106 is a RAM drive configured to emulate the missing hardware device 112, which in this embodiment is a floppy disk drive. The RAM drive could be a memory device separate from memory 104. In an alternative embodiment, the RAM drive may be created within memory 104. In another embodiment, the device emulator 106 may be a Universal Serial Bus (USB) hard drive that emulates a storage device.

FIG. 1 also shows a storage device 114 coupled to bus 108, in accordance with one embodiment of the present invention. Storage device 114 includes, but is not limited to, a magnetic disk drive, an optical disk drive, a magnetic tape drive, a random access memory, or the like. Storage device 114 can be used to load data into the device emulator 106. In an alternative embodiment, storage device 114 resides outside of computer system 100 and is communicatively coupled to computer system 100 via a network. Such a network may include, but is not limited to, a Local Area Network (LAN), a Wide Area Network (WAN), or a collection of LANs and WANs, such as an enterprise intranet or the Internet. The network connection may comprise a wired connection (e.g., Ethernet, token ring, etc.), a wireless connection including optical systems, satellite transmissions, or the like, or any combination thereof.

For reasons of clarity, only a single device emulator 106 is shown in FIG. 1. However, in alternative embodiments, a plurality of device emulators, of the same or different types, could be implemented in computer system 100 to mimic various hardware devices. In another embodiment having a plurality of device emulators, one or more of the device emulators could reside outside of computer system 100 and be accessible to computer system 100 via a network.

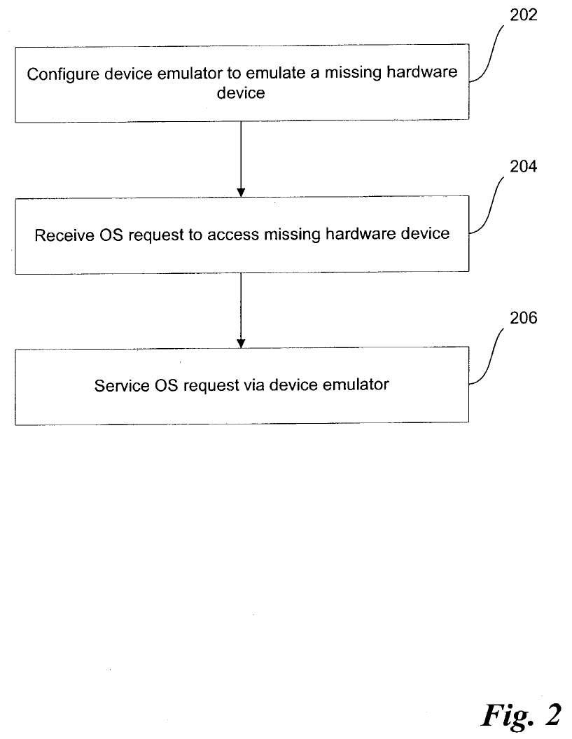

A flowchart illustrating further details of logic and operations performed in accordance with an embodiment of the present invention is shown in FIG. 2. The process begins in a block 202 to configure a device emulator in a computer system. To configure the device emulator, the computer system scheme is modified so that software, such as an operating system and/or an application, will perceive the device emulator as a particular hardware device. In one embodiment, the BIOS firmware of a computer system is modified so that any software that issues commands related to a missing hardware device will be directed to the corresponding device emulator.

During the operation of the computer system, the operating system requests to access a missing hardware device, as depicted in a block 204. From the OS point of view, the missing hardware device is present and available to the OS. However, the missing hardware device does not actually exist, but is simulated by the device emulator.

In a block 206, the request from the OS is serviced via the device emulator. The OS request to access the missing hardware device is directed to the device emulator such that the OS believes it is communicating with the missing hardware device. The OS conducts activity with the device emulator as if it is operating with the missing hardware device. In another embodiment, the request to access the missing hardware device is received directly from an application that bypasses the operating system. The application communicates directly with the BIOS firmware without operating system intervention. In this embodiment, the application request is directed to the device emulator and serviced by the device emulator in a similar manner as discussed above.

A flowchart illustrating further details of logic and operations performed in accordance with an alternative embodiment of the present invention is shown in FIG. 3. The embodiment of FIG. 3 is shown emulating a floppy disk drive with a RAM drive for the installation of operating system components on a computer system. The process begins in a block 302, which corresponds to a system startup event, i.e., a cold boot or a system reset.

In response to the startup event, pre-boot initialization of the computer system will begin stored in the computer system BIOS firmware, as depicted by a block 304. In one embodiment, the system boot instructions will begin initializing the client by conducting a Power-On Self-Test (POST) routine, initializing system board functions, checking for any expansion boards that hold additional BIOS code, and loading such BIOS code if any is found.

In a block 306, a RAM drive is installed on the computer system. It will be appreciated that the RAM drive is installed and accessed during the pre-boot phase. In an EFI compliant computer system, the RAM drive can be described in an EFI configuration table so that an OS present agent can find the buffer that represents the RAM drive.

In a decision block 308, the logic determines if the computer system is EFI compliant. If the answer in decision block 308 is yes, then the logic proceeds to a block 312, to configure an Advance Configuration and Power Interface (ACPI) device path to the RAM drive to “fake” a floppy disk drive.

A device path is used to define the programmatic path to a hardware device. The primary purpose of a device path is to allow an EFI application, such as an OS loader, to determine the physical device path that the EFI interfaces are abstracting. In one embodiment, to emulate a floppy disk drive, the EFI framework may advertise an ACPI device path node with a plug-and-play hardware identifier of 0×0604. After the device path is configured in block 312, the logic proceeds to a block 314.

Referring back to decision block 308, if the answer is no, then the logic proceeds to a block 310 to configure a handler for a non-EFI compliant system (also referred to as a “legacy” system.) The handler of block 310 is a BIOS routine to catch access requests to the missing hardware and re-route the request to the device emulator. In one embodiment, an interrupt INT13h handler is installed in the BIOS to re-route access requests from drive 0 (the floppy disk drive) to the RAM drive. After the handler is configured in block 310, the logic proceeds to block 314.

It will be appreciated that in one embodiment, a RAM drive can have both an INT13h handler and an ACPI descriptor. In this embodiment, the computer system can run both legacy and EFI aware operating systems. A platform can comply with the EFI specification and also support legacy OS binaries that have no knowledge of the EFI specification. The EFI specification does not prevent a platform from supporting both EFI and legacy BIOS infrastructures.

In block 314, data is loaded into the RAM drive. When the OS is looking for data stored in a particular storage device, the OS will perceive the device emulator as the storage device the OS is looking for and be provided data stored thereon. The operating system believes the computer system is populated with a hardware device that is not actually present. In one embodiment, the user is presented with a user interface during the pre-boot phase so that the user can load the RAM drive with data from a storage medium, such as a CD-ROM. In another embodiment, a system administrator employs a user interface during pre-boot to seed a RAM drive with the appropriate data for hardware devices in a network. For example, the system administrator knows that a given series of platforms in a network have a particular hardware device, such as a Redundant Array of Inexpensive Disks (RAID) controller, that is not supported by the base operating system installation. The OS installation will find the necessary device drivers on the RAM drive.

After data is loaded into the RAM drive, the pre-boot phase of the computer system is completed, as depicted in a block 316. In a block 318, the installation of an OS is conducted. In one embodiment, the OS installation occurs on a computer system that does not have the OS installed or the OS is not functioning properly. During such an OS installation, the OS typically asks for a floppy disk containing particular data to be placed in the floppy disk drive. When the OS makes a request to access the floppy disk drive, the OS request will in actuality be sent to the RAM drive. The data requested by the OS resides on the RAM drive because the data was seeded in the RAM drive in block 314. The BIOS will honor the OS request and provide the OS with the requested data from the RAM drive. In another embodiment, the OS installation involves installing a new driver on the computer system during OS run-time. In this case, if the OS asks the user for a floppy disk having the new driver, the OS will be provided with the requested data that was previously loaded into the RAM drive.

An embodiment of the present invention, as illustrated in FIG. 3, offers numerous advantages. Operating systems that make assumptions regarding the presence of particular hardware devices may be implemented on platforms that are shipped without these hardware devices. Computer system hardware can be advanced without being hindered by slower software evolution or outdated hardware requirements of legacy operating systems. Software applications and utilities that have been designed for use with certain hardware devices can be used on newly shipped platforms by way of “faked” hardware devices. In the case of an OS installation, emulating a floppy disk drive overcomes the problems associated with installing an OS on a platform without a floppy disk drive.

FIG. 4 illustrates an embodiment of an exemplary computer system 400 to practice an embodiment of the invention described above. Computer system 400 is generally illustrative of various types of computer devices, including personal computers, laptop computers, workstations, servers, etc. For simplicity, only the basic components of the computer system are discussed herein. Computer system 400 includes a processor chassis 402 in which various hardware components are housed, including a floppy disk drive 404, a hard disk 406, a power supply (not shown), and a motherboard 408 populated with appropriate integrated circuits including system memory 410 coupled to one or more processors 412. System memory 410 may include, but not is limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 412 may be a conventional microprocessor including, but not limited to, an Intel Corporation x86, Pentium, XScale or Itanium family microprocessor, a Motorola family microprocessor, or the like. Hard disk 406 may comprise a single unit, or multiple units, and may optionally reside outside of computer system 400. The system also includes a boot firmware device on which firmware is stored, which may typically comprise non-volatile memory such as a ROM device 420 or a flash device 422. Other non-volatile memory devices include, but are not limited to, an Erasable Programmable Read Only Memory (EPROM), an Electronically Erasable Programmable Read Only Memory (EEPROM), or the like. The motherboard may include other firmware devices as well (not shown). In general, the system's processors will comprise 32- or 64-bit architectures, and the system memory will include physical addressing schemes appropriate to the processor(s), and may be accessed via corresponding address and data buses to which the processor(s) and the memory are connected.

A monitor 414 is included for displaying graphics and text generated by firmware, software programs and program modules that are run by computer system 400, such as system information presented during system boot. A mouse 416 (or other pointing device) may be connected to a serial port, USB port, or other like bus ports communicatively coupled to processor 412. A keyboard 418 is communicatively coupled to motherboard 408 in a similar manner as mouse 416 for user entry of text and commands. In one embodiment, computer system 400 also includes a network interface card NIC or built-in NIC interface (not shown) for connecting computer system 400 to a computer network 430, such as a local area network (LAN), wide area network (WAN), or the Internet. In one embodiment network 430 is further coupled to a remote computer 435, such that computer system 400 and remote computer 435 can communicate. In one embodiment, a portion of the system's firmware is loaded during system boot from remote computer 435.

The illustrated embodiment further includes an optional add-in card 424 that is coupled to an expansion slot of motherboard 408. In one embodiment, add-in card 424 includes an Option ROM 426 on which firmware is stored. Computer system 400 may also optionally include a compact disk-read only memory (“CD-ROM”) drive 428 into which a CD-ROM disk may be inserted so that executable files, such as an operating system, and data on the disk can be read or transferred into system RAM 410 and/or hard disk 406. Other mass memory storage devices may be included in computer system 400.

In another embodiment, computer system 400 is a handheld or palmtop computer, which are sometimes referred to as personal digital assistants (PDAs). Handheld computers may not include a hard disk or other mass storage, and the executable programs are loaded from a corded or wireless network connection into memory 410 for execution by processor 412. A typical computer system 400 will usually include at least processor 412, memory 410, and a bus (not shown) coupling the memory 410 to the processor 412.

It will be appreciated that in one embodiment, computer system 400 is controlled by operating system software that includes a file management system, such as a disk operating system, which is part of the operating system software. For example, one embodiment of the present invention utilizes Microsoft Windows® as the operating system for computer system 400. In another embodiment, other operating systems such as, for example, but not limited to the Apple Macintosh operating system, the Linux operating system, the Microsoft Windows CE® operating system, the Unix operating system, the 3Com Palm operating system, or the like may also be used in accordance with the teachings of the present invention.

Thus, embodiments of this invention may be used as or to support a firmware and software code executed upon some form of processing core (such as processor 412) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). For example, a machine-readabel medium can include, but is not limited to, a read only memory (ROM), a random access memory (RAM), a magnetic disk storage media, an optical storage media, a flash memory device, or the like. In addition, a machine-readable medium can include propagated signals such as electrical, optical, acoustical or other forms of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
emulating a missing device of a computer system with a device emulator;
receiving a request to access the missing device; and
servicing the request via the device emulator.

2. The method of claim 1, wherein the missing device comprises a first storage device.

3. The method of claim 2, wherein the device emulator comprises a second storage device.

4. The method of claim 3, further comprising:
loading data into the second storage device, the data anticipated to be requested from the first storage device; and
providing the data from the second storage device in response to a request to access the data from the first storage device.

5. The method of claim 4, wherein the data requested from the first storage device comprises an operating system component.

6. The method of claim 4, further comprising providing a user interface in pre- boot of the computer system to load the data into the second storage device.

7. The method of claim 1, wherein receiving the request comprises receiving the request from an operating system of the computer system.

8. The method of claim 1, wherein receiving the request comprises receiving the request directly from an application without operating system intervention.

9. The method of claim 1, wherein emulating the missing device is performed via firmware.

10. The method of claim 9, wherein emulating the missing device comprises configuring the firmware to direct requests for the missing device to the device emulator.

11. The method of claim 9, wherein the firmware comprises Basic Input/Output System (BIOS) firmware to operate in accordance with the Extensible Firmware Interface (EFI) framework standard.

12. An article of manufacture comprising:
a machine-readable medium on which a plurality of instructions are stored, which when executed perform operations comprising:
emulating a missing device of a computer system with a device emulator;
receiving a request from an operating system executable on the computer system to access the missing device; and
servicing the request via the device emulator.

13. The article of manufacture of claim 12, wherein the missing device comprises a first storage device.

14. The article of manufacture of claim 13, wherein the device emulator comprises a second storage device.

15. The article of manufacture of claim 13, wherein the first storage device comprises a magnetic disk drive.

16. The article of manufacture of claim 14, wherein the second storage device comprises a Random Access Memory (RAM) drive.

17. The article of manufacture of claim 14, wherein execution of the instructions further performs the operations of providing a user interface in pre-boot of the computer system to load data anticipated to be requested from the first storage device into the second storage device.

18. The article of manufacture of claim 12, wherein instructions for emulating the missing device comprises instructions for configuring a Basic Input/Output System (BIOS) interrupt handler in firmware of the computer system to intervene in the request to access the missing device and route the request to the device emulator.

19. The article of manufacture of claim 12, wherein instructions for emulating the missing device comprises configuring a device path in firmware of the computer system to route access requests for the missing device to the device emulator.

20. The article of manufacture of claim 19, wherein the device path defined in accordance with the Advanced Configuration and Power Interface (ACPI) framework.

21. The article of manufacture of claim 12, wherein the plurality of instructions operate in accordance with the Extensible Firmware Interface (EFI) framework standard.

22. A computer system, comprising:
a processor; and
at least one flash device operatively coupled to the processor on which firmware instructions are stored, which when executed by the processor perform operations comprising:
emulating a missing device of a computer system with a device emulator;
receiving a request from an operating system executable on the computer system to access the missing device; and
servicing the request via the device emulator.

23. The computer system of claim 22, wherein emulating the missing device comprises configuring a handler in firmware, the handler to reroute access requests for the missing device to the device emulator.

24. The computer system of claim 22, wherein emulating the missing device comprises configuring a device path in firmware to route access requests for the missing device to the device emulator, the device path defined in accordance with the Advanced Configuration and Power Interface (ACPI) framework.

25. The computer system of claim 22, wherein the firmware instructions operate in accordance with the Extensible Firmware Interface (EFI) framework standard.

26. The computer system of claim 22, wherein the missing device comprises a first storage device and the device emulator comprises a second storage device.

27. The computer system of claim 26, wherein execution of the firmware instructions further performs the operations of providing a user interface to load data anticipated to be requested from the first storage device into the second storage device.
